(19) United States
(12) Patent Application Publication
(10) Pub. No.: US 2019/0205761 A1
(43) Pub. Date: Jul. 4, 2019

(54) SYSTEM AND METHOD FOR DYNAMIC ONLINE SEARCH RESULT GENERATION

(71) Applicant: ADEPTMIND INC., Toronto (CA)

(72) Inventors: Zhiyuan WU, Toronto (CA); Jing HE, Mississauga (CA)

(21) Appl. No.: 16/235,798

(22) Filed: Dec. 28, 2018

Related U.S. Application Data
(60) Provisional application No. 62/611,280, filed on Dec. 28, 2017.

(51) Int. Cl. G06N 3/08; G06N 3/04; G06F 16/33; G06F 16/9538

(52) U.S. Cl. CPC G06N 3/084; G06F 16/9538; G06F 16/3344; G06N 3/04

(57) ABSTRACT

A computerized neural-network based mechanism for providing an intermediary configured for intervening in searches is described. Corresponding methods, computer-readable media, systems, devices, and apparatuses are also contemplated. The neural network can include a multi-headed attention layer. The intermediary may be, in some embodiments, a human “man in the middle” mechanism invoked where there is low confidence that pre-existing categories map to a user's search string. The mechanism provides a specially configured interface adapted to enable a search specialist to quickly select one or more categories that match or are otherwise associated with the search query from a set of acceptable categories. Received outputs and detected user behaviors are utilized to update a neural network model.

### CROSS REFERENCE TO RELATED APPLICATIONS

This application is a non-provisional of, and claims all benefit to, including priority of, U.S. Application No. 62/611280, filed 28 Dec. 2017, entitled “SYSTEM AND METHOD FOR DYNAMIC ONLINE SEARCH RESULT GENERATION”, incorporated herein by reference in its entirety.

### FIELD

Embodiments of the present disclosure generally relate to the field of electronic querying, and more specifically, to the field of dynamic online search result generation.

### INTRODUCTION

Conducting search queries can be a frustrating experience, where searches, despite being free-text (or other types of unstructured input), are matched against pre-defined categories that are in a pre-existing taxonomy.

Imprecisions in language (e.g., syntactical imprecision), ambiguity in query terms, mismatches between search terms, contribute to search queries where there are low quality of potential matches or results returned in relation to the search query. Language informalities, etc., contribute to this challenge.

For example, a US-based retailer may receive a query from an Australian user for “thoing shoes”, which is a misspelling of an informal Australian term for “thongs”, and the user is actually interested in beach sandals of a particular design for securing the user's feet. The US-based retailer's categories may not be particularly well attuned to this search, and the system may be hesitant to return a webpage directed to swimwear given the presence of the term “shoes”.

Similarly, abstract search queries are also of increased difficulty to process by computers. A user enter a search for “dress good for beach” is likely searching for either a swimsuit or a lightweight dress, and it would be erroneous for the system to return beach umbrellas, or formal dresses, for example.

Improved mechanisms for increasing the quality of outputs are desirable.

### SUMMARY

Linguistic variations lead to difficult technical problems when attempting to computationally match products or services with entered query string terms. This problem is especially difficult in view of dynamic online search result generation, where there is limited available time to identify matches to the query string terms before the search becomes tedious or frustrating for a user.

Improved neural networking computational approaches are described herein, where a neural network comprised of a number of interconnected computing nodes implemented in hardware and software are maintained to computationally match products or services with entered query string terms. As described in various embodiments, the neural networking mechanism has technical modifications which improve the performance of the neural network, in view of the limited computational time and resources.

In some embodiments, a specially configured neural network is provided that utilizes multi-headed attention layers. Each possible semantic class corresponding to a specific head. The neural network is configured to provide multiple outputs adapted to construct multiple attention distributions.

The multiple attention distributions can be established simultaneously, and for each head of the neural network, one or more search terms expanded with a nonce/dummy search term are processed to establish a corresponding attention probability distribution associated with the corresponding semantic class. Each of the constructed multiple attention distributions are then utilized to identify one or more candidate categories associated with the search term from a pre-defined set of candidate categories, and to associate each candidate category with a confidence score.

The confidence score, in some embodiments, is then utilized to determine whether the query is submitted to a human agent interface (e.g., if below a particular confidence threshold). The confidence threshold may be dynamically determined based on a number of human resources available or expected to be available at a particular point in time. The human agent interface is configured such that on a display of a device, options are graphically represented having positions, spatial area, or orientation (or combinations thereof) modified based on the confidence scores of the candidate categories or the multiple attention distributions. For example, a higher confidence score result may be prominently positioned (e.g., proximate to the default mouse position cursor), or associated with a specific keystroke that is more commonly used by the agent (e.g., the “up keystroke”). The agent may then provide an input through which a computing device sends an input signal indicative of the correct categorization. In some embodiments, the agent's response is then utilized to retrain the neural network, reweighting interconnections of the neural network to generate an update.

A computerized mechanism for providing an intermediary configured for intervening in searches is described in various embodiments. Corresponding methods, computer-readable media, systems, devices, and apparatuses are also contemplated. The mechanism, of some embodiments, is a specially configured hardware appliance including optimized hardware for inclusion into a data center, adapted to process a plurality of low-confidence search result candidates to select one or more output search results selected from the low-confidence search result candidates.

The intermediary may be, in some embodiments, a human “man in the middle” mechanism, where a search specialist is provided with a specially configured interface adapted to enable the search specialist to quickly select one or more categories that match or are otherwise associated with the search query from a set of acceptable categories. The search specialist or intermediary may be invoked where there is low confidence that pre-existing categories map to the search string. Human-in-Middle (HiM) is a hybrid approach to enhance the search user experience. When a shop's end customer starts a search on the store site, the shop can send a request to the search endpoint. The search endpoint is a delegate that is adapted to coordinate the results from multiple components, and return the final relevant results to the end user.

For example, an interface may be configured to receive freeform inputs representative of search strings to querying a clothing retailer website. The interface can include a shop component that is configured to control what the users observe as a rendered search bar, the shop component controlling a display to render results when they are available. Components as described in various embodiments are, in some embodiments, software, hardware, or embedded firmware configured for providing computer functionality, and can include circuitry or processors executing machine interpretable instruction sets.

When the shop component receives a query from a user, it will construct the query request including other context information such as previous queries, selected filters, and user meta information.

The clothing retailer website is hosted by a server and has a database storing a list of product categories and product types. A user wishes to buy what are informally referred to as “ripped jeans”.

When the mechanism receives the search string indicative of the user's query, it first processes the query to determine a category that best fits the user's query. This request is transmitted to a delegator component, and the shop component will receive all the information of products that are considered relevant to the query, including product name, description, price, image, etc.

The delegator component is configured to transmit the query to a natural language processing (NLP) component, and receive the semantic information from the NLP component. The semantic information includes the categories and attributes extracted from the query. The category indicates what type of products the user is looking for, and the attributes indicate the properties of the products the user is looking for. For example, when a user is searching for “red jacket for women”. “Jacket” is the category of the query, both “red” and “for women” are two attributes, about color and gender respectively. To support the HiM approach, the NLP component generates an output related to the confidence of the model, which for example, may be a score, in some embodiments, or a prioritized order of the recommendations stored within a data set or structure, such as a linked list or an array.

In particular, a mapping is conducted to traverse one or more data structures stored on the clothing retailer website database to determine a match. A perfect confidence match occurs where there is identical mapping, and high confidence scores may be allocated in relation to minor syntactical differences, spelling mistakes, plural vs singular forms, etc.

After obtaining the semantic information about the query, the delegator component is configured to transmit the original query together with the extracted semantic information to the search component.

A search component generates search queries based on the content in a processed store catalog (e.g., a mapping data structure), and return a list of products in respect of the query string and semantic information (e.g., a mapped data structure). To support the HiM model, the search component, in some embodiments, transmits additional information that is related to the confidence of the model as part of the response in the form of a data structure or an encapsulated data message.

The search component receives both the original query string and the semantic information, and identifies the related product list for the query. The search component can include a pre-built index containing the information about the products in the store. The index does not contain the text information, but also the semantic understanding information, i.e., categories and attributes about the products. Therefore both the surface text and semantic information can be matched. The search component will first combine the text and semantic information from the query and build a structured query to include both. Then the search will send the query to the index. The index returns a list of product results, each of which has a matching score. These scores will be returned together with the search results, reflecting how good the matching is.

The NLP component provides a list of query words that are not understood by the NLP models. The search component will get additional information about these words, including 1) if each word is matched with certain results; 2) how many results are matched to each word; 3) how many results are matched to the combination of the words; These statistics information will be sent back to the delegator component.

After receiving both results from the NLP component and the search component, the delegator component is configured to transmit data sets representing the original query, semantic information, search results and meta features from both components to the model rejector component. The model rejector component computationally derives a decision field value on how confident the result is and send the decision field value back to the delegator component in the form of a control signal. The decision to go to a human agent or not is decided by the model rejector component. This component obtains a portion or all the information sent from the delegator component collected from both NLP component and search component. All the information has been covered in the description of these two components. This information can include: a risk estimate from the semantic prediction (NLP), an uncertainty estimate from the semantic prediction (NLP), coverage features from the semantic prediction (NLP), matching score features (Search), and uncovered words statistics features (Search). All or a portion of these features are aggregated together to predict the confidence about the overall search results. A supervised machine learning model is used to make this prediction.

The training data set is composed by the multiple store catalogs. For each store catalog, a set of queries related to this store are selected, and the relevant product results are labeled. Given this raw training data set. The confidence of the search results should reflect the actually search result quality, i.e., the model rejector should more likely to reject the result when the search result quality is low. One regression model is trained to make the prediction.

If the model rejector component generates a decision signal that rejects the current search results because of the low confidence of the result, the delegator component needs to send both the search query and results to the agent component. The agent will send back the relevant results or no results found. If the model rejector component decides to not reject the current search results because the confidence is deemed high enough, the delegator component is configured to transmit the current search results back to the user right away.

The determination of the model rejector component, in some embodiments, is modified based on a detected availability of human-in-the-middle resources at a particular time. For example, if there are a larger amount of resources available (e.g., ten agents), the model rejector component may apply a higher threshold for confidence for automatic classification, and if there are less resources available (e.g., one agent), the model rejector component may apply a lower threshold for confidence for automatic classification. Accordingly, the amount of acceptable error may be tunable based on available resources. Availability of resources may be based on a number of resources available, or in an alternate embodiment, is determined based on the monitored effectiveness and speed of each resource (e.g., not all agents are the same). From a user perspective, they can be unaware of the backend human resources Similarly, the availability of resources may depend on hours of operation of the backend human resources.

In an embodiment, the human agent graphical user interface renders an interface having interactive interface elements whose visual characteristics (e.g., positioning, surface area) relative to an input mechanism (e.g., touch, keyboard, mouse) are adapted based on confidence scores attached to specific categories established through the neural network. Proportional to the confidence scores, increased visual or ease of selection prominence is attached to the interactive interface elements. The received selections from the human agent graphical user interface are stored as downstream training data for retuning the neural network.

In an embodiment, the system includes a training feedback circuit that utilizes agent feedback for continuous learning (e.g., retraining of the neural network). The agents' feedback comes to the continuous learning component so it can be used to improve the query understanding component. The agents modify the activated semantic classes to update the search results as a more efficient manner. The updates on these semantic classes provide informative signals to update the weights in the neural network. The feedback data are used as additional training to fine tune the query understanding network. The system is retrained periodically with these incremental training data. The training process is a multi-task learning process.

Accordingly, as the model is updated based on feedback from the agents, the user interfaces will shift over time to devote more and more emphasis (e.g., surface area, default positioning) to specific categorization outputs.

In alternate query understanding model training, the neural network is adapted to perform three tasks. For continuous learning, an embodiment utilizes a new data stream that is used as another task. All these four tasks run in parallel, but the data sampling mechanism is different. Since the model is trained well on 3 existing tasks, the focus of the training is on the newly collected dataset. A technical improvement is a higher sampling probability from the new dataset from the agents' feedback, which helps cause the training process to converge faster relative to a model without the tasks being conducted.

In an aspect, there is provided a computer implemented method for dynamic online search result generation, the method comprising: receiving a search string representative of a query; processing the search string to extract one or more search terms; for each search term of the one or more search terms: identifying one or more candidate categories associated with the search term from a pre-defined set of candidate categories; processing the one or more candidate categories to associate each candidate category with a confidence score; upon determining that none of the one or more candidate categories has a confidence score above a threshold value: associating each of the candidate categories with one or more visual characteristics based on the confidence scores; rendering an interface display screen based on the one or more visual characteristics, the interface display screen including interactive visual elements that selectable in relation to the one or more candidate categories; receiving, from an input device, a selected subset of the one or more candidate categories; and generating an output representative of the selected subset of the one or more candidate categories.

In another aspect, wherein the interface display screen is configured to render a constellation of visual elements representative of the one or more candidate categories.

In another aspect, wherein the constellation includes a visual rendering of selectable areas, each selectable area representative of a candidate category of the one or more candidate categories.

In another aspect, wherein each selectable area is rendered based on the visual characteristics, and the visual characteristics include at least one of screen area, color, position, and shape.

In another aspect, wherein each selectable area is an area configured for receiving at least one of a touch input and a mouse input.

In another aspect, the method further includes providing the output to a neural network configured to optimize the confidence scores associated with each of the one or more categories.

In another aspect, the neural network conducts the processing of the one or more candidate categories.

A system configured to perform the method of any one of the above embodiments, the system including at least one processor, computer readable memory, and non-transitory computer readable media.

A non-transitory computer readable medium storing machine readable instructions, which when executed, cause a processor to perform the method of any one of the above embodiments.

In various further aspects, the disclosure provides corresponding systems and devices, and logic structures such as machine-executable coded instruction sets for implementing such systems, devices, and methods.

In this respect, before explaining at least one embodiment in detail, it is to be understood that the embodiments are not limited in application to the details of construction and to the arrangements of the components set forth in the following description or illustrated in the drawings. Also, it is to be understood that the phraseology and terminology employed herein are for the purpose of description and should not be regarded as limiting.

Many further features and combinations thereof concerning embodiments described herein will appear to those skilled in the art following a reading of the instant disclosure.

### DESCRIPTION OF THE FIGURES

In the figures, embodiments are illustrated by way of example. It is to be expressly understood that the description and figures are only for the purpose of illustration and as an aid to understanding.

Embodiments will now be described, by way of example only, with reference to the attached figures, wherein in the figures:

FIG. 1 is a block schematic diagram of an example system for dynamic online search result generation, according to some embodiments.

FIG. 2A is a block schematic diagram illustrating example components of the system configured for conducting dynamic search, according to some embodiments.

FIG. 2B is a neural network schematic diagram illustrating an example structure for a multi-headed neural network, according to some embodiments.

FIG. 3A is a screenshot of a search input field that may be used by a user to input a search string in this case, in relation to lawnmowers, according to some embodiments. FIG. 3B is a screenshot showing changes to FIG. 3A following the selection of a filter, and FIG. 3C is another screenshot following the selection of another filter.

FIG. 4 shows an alternate rendering where there may be multiple fields available for input aside from search fields, according to some embodiments.

FIG. 5 is an example rendering an interface or a search specialist. The rendering shows space that is streamlined for use by search specialist, according to some embodiments.

FIG. 6 depicts a similar interface, however, relative to FIG. 5, different categories shown are with different visual renderings, including position, area, and distance from the default mouse position, according to some embodiments.

FIG. 7 is an alternate rendering whereby rather than being optimized for a mouse selection, the interface is designed for interaction with the search server search specialist by way of a touch action in the middle, according to some embodiments.

FIG. 8 is an example method for conducting online searches with an intermediary mechanism, according to some embodiments.

FIG. 9 is an example method for rendering the visual elements for the supervised user interface, according to some embodiments.

FIG. 10 is a block schematic diagram of an example computing device, according to some embodiments.

### DETAILED DESCRIPTION

A computerized mechanism for providing an intermediary configured for intervening in searches is described in various embodiments. Corresponding methods, computer-readable media, systems, devices, and apparatuses are also contemplated. The mechanism, of some embodiments, is a specially configured hardware appliance including optimized hardware for inclusion into a data center, adapted to process a plurality of low-confidence search result candidates to select one or more output search results selected from the low-confidence search result candidates.

For example, an interface may be configured to receive freeform inputs representative of search strings to querying a clothing retailer website. The clothing retailer website is hosted by a server and has a database storing a list of product categories and product types. A user wishes to buy what are informally referred to as “ripped jeans”.

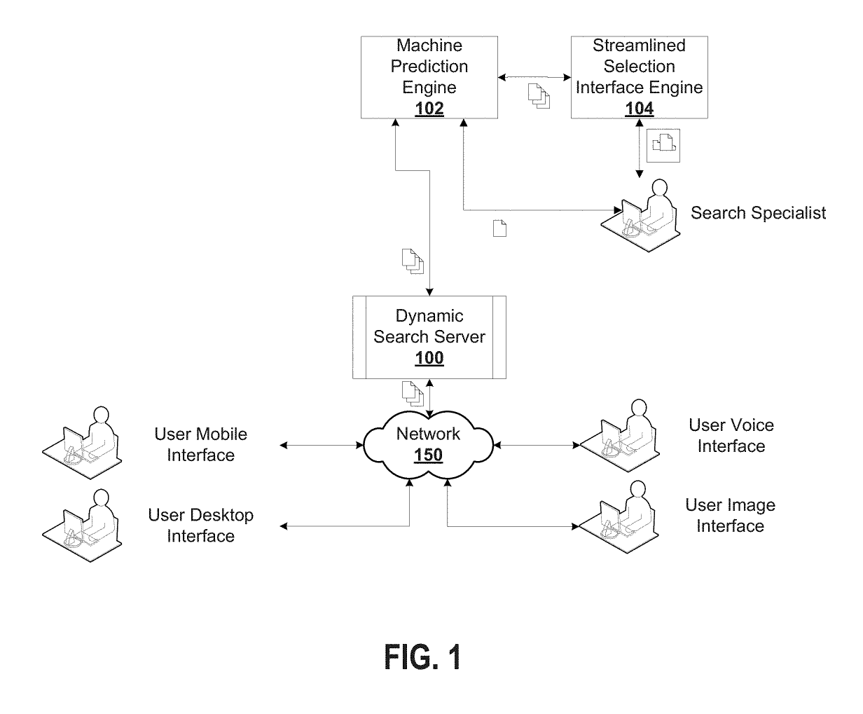

FIG. 1 is a block schematic diagram of an example system for dynamic online search result generation, according to some embodiments. The system is implemented using one or more processors, operating with computer memory, storage devices, and communication networks.

In FIG. 1, a dynamic search server 100 is shown, and the dynamic search server 100 receives, across network 150, search strings from at least one of a user mobile interface, user desktop interface, user voice interface, and a user image interface.

From the user mobile interface for example, a user may be able to submit a search string through a form field as part of an interactive visual element rendered on the webpage such that the search string would represent, in an example, desired keywords in relation to a potential search by the user. Example situations may include, online shopping, web searches, newspaper searches, services searches, among others. In some embodiments the search string is provided through a rendered desktop interface which may be provided by way of a workstation, display, an input device, such as a keyboard, or a mouse input.

In an alternate embodiment, a user voice interface is provided where voice is received in form of a signal that is transcribed into a search string. For example, a voice recorder such as a microphone, or a voice file receiving device or mechanism may be used. In an alternate embodiment, an image may be uploaded or otherwise linked to in a corresponding hyperlink in a search field. This image is utilized and image processed to extract a set of keywords that resemble one or more visual features represented in the image. These search strings are transmitted across network 152 to the dynamic search server 100.

The search string represents the user's input query, and the dynamic search server 100 is configured to provide a seamless, transparent interface upon which the user is returned one or more relevant keywords and or various workflows are initiated.

The keywords may not always be provided in the form of search results, but in alternate embodiments, the dynamic search server 100 provides improved keywords and/or suggestions that more closely match known categories, products, services, or other types of defined terms.

For example, a user may perform a search for “clothes for 1 year old boy”, and the dynamic search server 100 may, in addition to or rather than providing an improved search page, may instead control a display to render improved suggestion bubbles (“drum set”, “giraffe pull toy”, “large-scale building blocks”, “non-toxic plastic toys”), among others. These improved suggestion bubbles may either be automatically generated, or generated using a “man in the middle” mechanism that is otherwise transparent to the user (e.g., a search specialist using an improved selection interface to quickly select keywords responsive to the search, and training a neural network over a corpus of data such that over time, automatically generated suggestion bubbles may be of sufficient confidence such that they can be automatically provided without the use of the “man in the middle”.

For example, a customer may input a query string “chanel number 5”, yet the model has never received a query having a similar semantic structure. The model, when processing the query, may recognize the token “chanel” as a brand name, but it may mistakenly recognize “number 5” as a product ID.

The human agent from the cosmetic shop knows the domain so well, so they know that it is actually a kind of perfume, so they use the perfume filter to find this exact perfume or something similar. In this process, the association between “chanel number 5” and the semantic class “perfume” is set up, and a training example is created in the continuous learning process.

The learning process happens periodically. Once this happens, this example is taken in the training. The training process is a multi-task learning approach, so the method picks training examples from previous three stages (1. domain independent, task independent data; 2. domain dependent, task independent data; and 3. domain dependent, task dependent data) as well but with a lower sampling budget, but it has much higher sampling budget from the new examples including the one in the previous example. After the training process converges, it stops training and the new association is learned.

Workflows, for example, may include the rendering of search pages showing products that are of interest to the user, such as bicycles, consumer-products, shampoos, and so forth. One challenge with search is that keywords provided by users do not often have a strong match which with keywords that are parse-able by the server.

In this situations, an undesirable outcome may be that either no results are shown to the user, or irrelevant results are shown to the user. This occurs in many situations, as lexicographical, informality, and ambiguity issues are present in human language.

When the mechanism receives the search string indicative of the user's query, the dynamic search server 100, in certain situations, feeds the search string into machine learning unit engine 102, which makes a confidence decision in relation to the search string and associated keywords for initiating workflows.

Machine learning unit engine 102 processes the query to determine a category that best fits the user's query. The mapping is conducted to traverse one or more data structures stored on the clothing retailer website database to determine a match. A perfect confidence match can occur where there is identical mapping, and high confidence scores may be allocated in relation to minor syntactical differences, spelling mistakes, plural vs singular forms, etc.

Where the confidence level is particularly low, indicating ambiguities in text, the search string and or the identified keywords is provided to a streamlined selection interface engine 104. In an example, the clothing retailer website database does not have a corresponding entry, and there is a lack of clarity in relation to what constitutes “ripped jeans”.

The computer generated decision of whether a classification requires a man in the middle/transfer to search specialist interface unit 216 is modified based on a detected availability of human-in-the-middle resources at a particular time. For example, if there are a larger amount of resources available (e.g., ten agents), the model rejector component of neural network 212 may apply a higher threshold for confidence for automatic classification, and if there are less resources available (e.g., one agent), the model rejector component of neural network 212 may apply a lower threshold for confidence for automatic classification.

Where the model rejector component of neural network 212 determines that a query should be transmitted to search specialist interface unit 216, a data structure storing a prioritized set of candidate keyword classifications is provided to the search specialist interface unit 216.

The search specialist interface unit 216, in some embodiments, is configured to track an availability and/or performance speed of various human agents to determine an aggregate human resource availability. The amount of acceptable error may be tunable based on available resources. Availability of resources may be based on a number of resources available, or in an alternate embodiment, is determined based on the monitored effectiveness and speed of each resource (e.g., not all agents are the same).

The clothing retailer website database instead, has a number of potential candidate categories that might map on to the user's query, such as “distressed jeans”, “used pants”, “corduroy pants”, among others. All of these potential candidate categories are assigned a confidence level based, for example, on a neural network that attempts to map the query string to the candidate categories. However, none of the potential candidate categories have a sufficiently high score to overcome a pre-defined threshold.

The streamlined selection interface is used to provide an intermediary mechanism, which may be, in some embodiments, a human “man in the middle” mechanism, where a search specialist is provided with a specially configured interface adapted to enable the search specialist to quickly select one or more categories that match or are otherwise associated with the search query from a set of acceptable categories. The streamlined selection engine 104 is a specially configured backend that is configured for interoperation with the search specialist. The streamlined selection engine 104 generates a dynamically rendered interface that is used by a search specialist in quickly selecting one or more candidate categories that best fit the user's query.

In some embodiments, the search specialist is a human being who selects on a highly streamlined interface a more relevant keyword for association with the users search string or parse versions thereof. In an effort to emulate strong matching, the streamlined selection engine 104 is adapted to render these representations to the search specialist in a very time sensitive matter whereby with minimal movements or actions taken the search specialist is able to indicate which keywords best associate with the search string itself. In alternative embodiments, the search specialist is not a human, but rather is a neural network configured to learn and adapt feedback over a period of time.

Accordingly, the speed at which the candidate categories are processed is an important factor in some embodiments. The dynamically rendered interface includes visual elements that are specifically rendered having various visual and/or interactive characteristics that allow the search specialist to easily and accurately select candidate categories in response to the search string. The search assistance of the intermediary is adapted to be as seamless as possible to the user experience. A user, on a retailer website, for example, may experience a slightly longer search time, but is typically unaware of the actions of the intermediary, as the search may take only a few seconds longer than usual (e.g., and there may be a corresponding visual indicator that the search is in progress, such as an hourglass or a spinning ball).

In some embodiments, a hybrid approach is adopted whereby the streamlined selection interface engine 104, over time, modifies how visual interface elements are presented to the search specialist, for example rendered on the display, such that, for example, the visual size the color orientation the position that distance from a default cursor position are optimized to bias the search specialist towards particular keywords. In an example, the user sends a search string requesting “ripped jeans”.

In relation to this example, the dynamic search server 100 receives a search string from network 150 and parses the search string to identify the keywords. In this case, the keyword is “ripped jeans” but the closest category is actually “distressed jeans” on the categories available to the system for returning query results. In a system without such a mechanism for improving search results, when the user submitted ripped jeans, no results or erroneous results would be returned.

Using the dynamic search server 100, the system instead sends the search string to the machine production engine 102 which recognizes a set of candidate keywords, such as, distressed jeans, used pants, ripped garments, among others, and determines how to visually arrange these elements onto a rendering which is generated by us streamlined selection interface 104. This rendering is then interacted with by the search specialist who, using an input device, selects a best keyword that resembles the term ripped jeans from the side of keywords starter are acceptable by the system. In this example, the search specialist essentially acts as a man in the middle. The man in the middle thus transparent to the user is able to modify and effectively fix the search strings such that the sub strings now match the substrings that are acceptable by the system, and a search result for ripped jeans brackets corresponding to distressed jeans bracket is returned to the user across network 150.

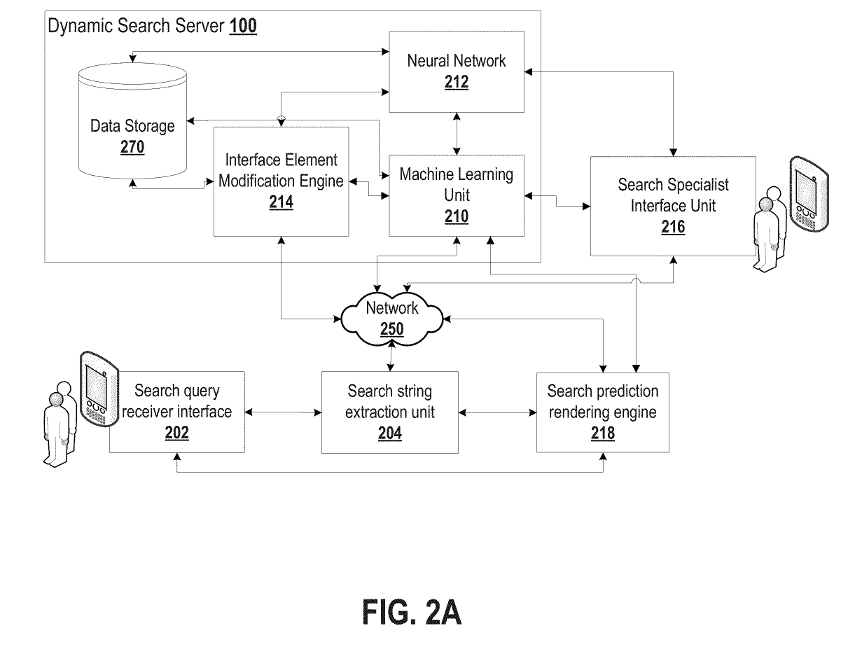

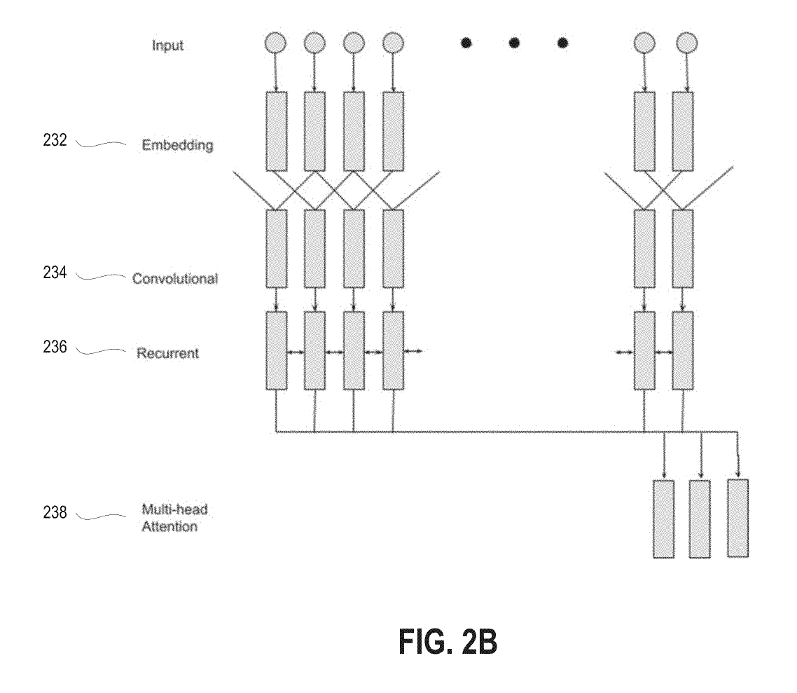

FIG. 2A is a block schematic diagram illustrating example components of the system 100 configured for conducting dynamic search. Dynamic search server 100 is configured for transparently receiving search springs from a user and responding either a set of relevant corresponding keywords from a set of known keywords for system, or initiating one or more workflows automatically that lead to rendered to face screens being presented to the user in response to the users search string.

Dynamic search server 100 is particularly useful where the search string from the user is not an exact match to a particular keyword and a match needs to be found by the system 100. A search string is received at search for a receiver interface 202 and this, as described in, FIG. 1 can be in the form of a text search string, a visual image search, a voice search, among others.

Search string extraction unit 204 is configured to parse, tokenize, process, or otherwise extract one or more word units from the search string. In some embodiments, compounds search terms are identified and split a separate terms. In certain situations this is easier to identify than others, for example, where search string is provided to the interface that has clearly indicated the delimitations between search terms.

A text input field, for example, may receive multiple in and they may be received deferred fields. In the context of images or audio system may respectfully identify segmentation between particular. These tokenized search strings are sent to network 250 network 250 is adapted to provide search strings to the dynamic search server 100 which the transmits the search strings to machine learning unit 210.

Machine learning unit 210 is configured to identify whether or not the search string sections correspond to known category of the system, for example, to determine whether such search strings are actionable by the system. With each associated keyword, a confidence score may be assigned by the system based on a level of similarity. For example, if there is an exact match the confidence score would be 100 or if there is slight deviations, for example, spelling mistakes, then the confidence score may be fairly high. On the other hand where there partial matches, or no matches at all, then the confidence score would be lowered.

In situations where the confidence scores below a particular threshold, system then they need to conduct a supervised “man in the middle” type approach where a search specialist is required to make an association between the search string section and the corresponding keywords for processing. The neural network 212 generates a confidence score that is used by the machine learning unit 210 to determine whether or not such search string portion should be sent to the search specialist.

Where the confidence scores below are particular threshold, the search string section is transmitted to the interface element modification engine 214. The interface element location engine 214 adaptively renders one or more search specialist interfaces based on the expected keywords associated with the search string, as generated by neural network 212. These expected search strings, corresponding search terms, are stored in data the search strings are candidates for association with the users search, and are rendered on display provided by search specialist interface unit 216.

### NLP and Query Understanding Component

The NLP component processes and interprets the original query string, and parses it into the semantic understanding information. The semantic understanding information includes two types of information: the categories and the attributes. One category classifier model is utilized to understand the categories of the query.

A machine learning model is built to pass the raw query string as the input and output a list of the categories related to the query. An attribute detection model is utilized to understand the attributes of the query. In addition to the original query string, the category information about the query is also treated as the input for the attribute detection model. A machine learning model is built on neural network 212 to parse the attribute information for the query.

As described in various embodiments herein, the neural network 212 is an improved mechanism that utilizes multi-headed analysis to improve prediction accuracy given a limited processing time and processing resources.

FIG. 2B is a neural network schematic diagram illustrating an example structure for a multi-headed neural network, according to some embodiments. As shown in FIG. 2B, the neural network includes multiple layers, including, for example, an embedding layer 232 a convolutional layer 234, a recurrent layer 236, and a multi-head attention layer 238.

The machine learning model of some embodiments is an improvement over alternate approaches, as:
The category information is provided into attribute detection network, so this category information is used as the context of the attribution detection model; In particular, the category information is encoded as a vector and fed into each step of the network. For example, if there are 200 categories, and the category vector has 200 bits, and each bit can be 1 or 0 (meaning this category is activated or deactivated). This vector is concatenated with the embedding for each word. So if a word embedding vector has 300 dimensions, it actually has 500 dimensions after the embedding layer for each token due to the extension based on the category information;
An improved multi-headed attention model for attribute detection is provided, and
An improved multi stage (e.g., 3 or 4 stage) training procedure is provided.

In an non-limiting example, the query is: burgundy pants for men, which can be tokenized as: [burgundy] [pants] [for] [men].

For the fashion domain, there can be heads corresponding to different aspects of fashion items, including categories of fashion items, material, color, gender, age, size, style, etc.

Each particular value of those aspects corresponds to a head in the network. For example, heads related to the material can include “material-cotton”, “material-silk”, “material-nylon”, etc.; heads related to the color can include “color-red”, “color-yellow”, “color-blue”, etc; There are overall hundreds to thousands of such heads for each domain.

These heads can point to any of these tokens, but such pointing is soft, i.e., it specifies a distribution of each head pointing to each token. For example, in one iteration of training, for the head corresponding to “color-red”, the pointing distribution can be {burgundy:0.1, pants:0.4, for: 0.3, men: 0.1, dummy-word: 0.1} (all probabilities sum up to 1.0). Note that the distribution is not perfect or even totally wrong in the middle of the training process.

The dummy-word is a nonce term that is utilized to improve accuracy. After Cony Layers and Recurrent Layers, each of these four words has a vector representation: v1, v2, v3, and v4; (all these are calculated in the forward pass of the network). A vector representation v0 is added at the end; (v0 is a part of the parameters). For one candidate label, for example, “material-denim”, it has a vector representation v′, so the weight of attention for each of these four words are exp(prod-dot(v1, v′)), exp(prod-dot(v2, v′)), exp(prod-dot(v3, v′)), exp(prod-dot(v4, v′)); the weight of attention for this dummy word is exp(prod-dot(v0, v′)), so the overall distribution of head for “material-denim” for this dummy word is exp(prod-dot(v0, v′))/[exp(prod-dot(v1, v′))+exp(prod-dot(v2, v′))+exp(prod-dot(v3, v′))+exp(prod-dot(v4, v′))+exp(prod-dot(v4, v′))].

If this is training, and it is known that “material-denim” is not related to this query, the expected distribution on this dummy word should be close to 1. If this probability is smaller, the backpropagation process pushes it to be larger value. The nonce/dummy term can prevent the network learns random association between “material-denim” with any of these four words.

For the example “burgundy pants for men”, the labels will tell the model that this query is associated with labels “color-red”, “category-pants” and “gender:male”, but it does not tell the model which word is corresponding to which label, so the pointing is not explicitly specified in the labels.

For example, the pointing distribution for the “color-red” head is {burgundy:0.2, pants:0.4, for: 0.2, men: 0.1, dummy-word: 0.1}. Then the prediction for “color-red” is based on the combined representation of these weighted words. Because the weight of related word “burgundy” in this case is so small, the network cannot know the combination is related to “color-red” and it predicts that the probability of activating “color-red” is 0.1.

The loss function is directed at the actual label, and see “color-red” should be activated, so the penalty is calculated by—log(0.1), which is a positive value, meaning such prediction gets loss/penalty due to its mistake. The backpropagation occurs after the loss is determined. The backpropagation observes for the direction of parameter changes that can reduce such loss.

A good direction to go is to increase the weight of the word “burgundy” for the label “color-red”. After a few iterations of training, the pointing distribution for “color-red” can be changed to {burgundy:0.9, pants:0.02, for: 0.01, men: 0.04, dummy-word: 0.03}.

A validation set may then be utilized, for example, where the query is: black hat for safari, tokenized as: [black] [hat] [for] [safari]. It has the same number of heads as training such as “color-red”, “color-yellow”, “material-cotton”, etc.

After the training, the head pointing is expected to much more accurate. In an example:
Head 1: “color-red”: {black: 0.02, hat: 0.02, for: 0.01, safari: 0.05, dummy-word: 0.9}
Head 2: “color-black” {black: 0.95, hat: 0.01, for: 0.02, safari: 0.01, dummy-word: 0.01}
Head 3: “category-hat” {black: 0.01, hat: 0.98, for: 0.0, safari: 0.01, dummy-word: 0.0}

Monto-Carlo sampling can be applied in the prediction time, the above is just one of the n samples from the sampling process. Such samples contain uncertain information. For example, the network does not really understand the word “safari” in this context, and it can accidentally associate this word with some other random attributes time to time, but such association has larger variance (i.e., it says this hat is yellow from one sample and says this is made of grass another time).

Predicted output: the prediction output can be positive for “color-black” and “category-hat”, but negative for all other labels.

In this case, a large variance for certain label output is a good indicator that the classifier does not have enough information for this query. In some embodiments, the classifier collects other information such as how close is each class's prediction to the margin (0.5). It's likely no actual head is pointing to the word “safari” (e.g., no head pointing to this word with probability more than 0.1), so the query understanding coverage feature indicates that this word is not covered. At this point, the system is adapted to revert to the search coverage feature to check if this word “safari” is covered by the explicit text in the catalog in the context of hats, it's very likely not much product description mentions hats in the context of “safari” (e.g., there are 50K hats, but only 2 mention safari), so the catalog coverage for this word is also low.

Combining all these determinations, the unknown classifier or answer quality evaluator can tell neither the query understanding model nor the explicit text matching from the catalog can capture full semantic representation for this query, and it will give it a lower confidence score, which may then be utilized in a downstream determination of whether a query should be sent to a human in the middle agent interface. A technical improvement for the answer quality evaluator is the use of the combination of these features from different components: features such as the risk, the uncertainty and the coverage from the multiple heads attention are extracted from another machine learning model used in the query understanding; and the search coverage and search quality features are from the search component.

The overall confidence score of a query is determined by another learning to rank model (e.g., random forest) combining all the features described as above.

All the activated labels will be displayed as selected filters on the result page, and the top inactivated labels (those labels that have prediction likelihood lower but close to 0.5) are listed on the result page, so the agent can easily activate/deactivate those filters. For example, a user may see a number of labels showing up in response to the query.

However, the confidence score may be low, and on the backend, a corresponding agent may be reviewing the outputs in real-time or near-real time and adding or removing filters. Accordingly, the user may observe a dynamic shift of filters being shown. For example, if the model predicts the color to be green from this query, the color green is selected and displayed on the search result page. If the agent does not agree to it through an indication on the agent interface, she can cross this filter, and the search results are updated to remove the constraint of color green.

The quality of answers from the agent can be evaluated by the following reinforcement signal from the end-customers. After an agent picks a list of relevant products (and filters), the end customer continues to interact with the shop (look at the product, navigate from one product to another, navigate from one product to its category, continue to search and filter, etc.), and such sequence of interaction actions indicates how much engagement this customer is and it is used to predict the likelihood of conversion this customer is. This conversion score is used as the weight of the training example.

### NLP and Query Understanding Component—Input/Output Translation for Deep Neural Network

This system, in some embodiments, uses deep neural networks to predict the semantic understanding of the text information. Deep neural network is a machine learning model that transforms an input vector to an output vector with a steps of non-linear transformations such as convolutional layers 234, recurrent layers 236 and multi-head attention layers 238. This part describes the input/output translation. The input translation transforms the text into a vector representation, while the output translation transforms the output vector into the semantic understanding.

Before sending the query into the deep neural networks, text preprocessing is conducted. Such preprocessing include tokenization, stemming and non-alphabetic processing. After the preprocessing, the input text is translated to a list of words. For example, the query “red jackets for women” is translated into a list of words [red, jacket, for, women].

Then a vectorization step is taken to translate each word into its corresponding index. Such a translation is done with a word-index dictionary. For example, there are total 5 million words in the vocabulary, “a” is the first word, so it has the index 1, and “zzzz” is the last word, and it has the index 5,000,000. After this step, the query “red jacket for women” is translated into a list of word index for example [3787489, 1283811, 88371, 4314710].

After the vectorization step, the input query is converted as a vector of integers. Usually, a deep neural network takes a vector of fixed shape, so a padding step is used to add special integer index at the beginning of the list so vector has a fixed length (e.g., 100). After this step, the query “red jacket for women” is translated into a list of word index with 96 ‘0’s as the head.

After the padding step, the input query is transformed into a fixed length integer vector. This neural network runs one or more non-linear transformations and the output is another vector.

All layers in the following section describes about the transformation from input to output; To be clear, we can put them together. Assuming the fixed length of the input after padding has 50 integers. It goes through the following layers:

1. Embedding layer 232: this layer transforms each integer (index of word) to its vector representation, so the output of this is 50×300 (assuming to use 300-dimension embeddings).

2. Cony-layer 234: this layer transforms the local context of words to vector representations. Assuming the output of one of the cony-layer is 500, and then the output of this layer is 50×500. The size 500 vector of each position (50 positions in total) already encodes the local context information.

3. Recurrent layer 236: this layer encodes the long-distance context information. Assuming the output of recurrent neurons is a size 300 vector, then the output matrix is 50×600, because we always use bi-directional recurrent layer.

4. Assuming we have 1000 candidate semantic classes in total, the multi-head attention layer 238 will build a cross-position distribution for each of the classes, so it will output 1000×50 matrix. Then the attention layer 238 will incorporate with the previous layer output to build a 1000×600 matrix (weighted average of recurrent layer output based on the attention weight).

5. The output layer is a linear transformation to translate the each 600-length vector to one scaler number between 0 to 1.

The length of the output vector is the number of semantic classes (including categories and attributes), each position of the vector is corresponding to one semantic class such as “Is this text about jacket”, “is this text about color red”, etc. And the value in the vector ranges from 0 to 1.

In FIG. 2B, the figure demonstrates three headed attention, as each block at right bottom corner is one attention head.

Each head is corresponding to one semantic class, and the mapping is enforced by the training process, which makes the network understands which part of sentence or which subset of words it should focus on generating correct decisions on each of the semantic classes.

The larger value means that the model is more confident that this semantic class is true. The system takes 0.5 as a threshold to decide if a semantic class is related to the text or not. When the semantic class is considered as related, this semantic class is activated. The system will output all the semantic classes that are related to the input text as the semantic understanding.

### NLP and Query Understanding Component—Neural Network Architecture

Components of the neural network include an embedding layer, a few convolutional layers, a few recurrent layers, one multi-head attention layer, and one output layer.

### NLP and Query Understanding Component—Neural Network Architecture—Embedding Layer

The embedding layer of the network is a matrix mapping from word indices to a distributed representation, (e.g., the embedding vector). For each word in the vocabulary, it has a corresponding vector representation. Using the same example above, if the output embedding vector length is 200, the embedding matrix dimension is (5,000,000, 200). The embedding matrix can be shown in an example as follows:

a: [0.33, 0.47, −0.34, ..., −1.12, 0.01]
...
...
...
zzzz: [−0.98, 0.55, 0.47, ..., 0.98, −0.78]

The embedding vector of each word preserves the semantic meaning of that word, and the operations on those vectors can show the semantic relations.

For example, the meaning of words “pants” and “trousers” are very similar to each other, and the similarity (usually measured by cosine similarity) between the embedding vectors of these two words should be high. After the embedding layer, the input vector is translated to a matrix with number of tokens rows and number of embedding dimensions columns.

In the above example, the preprocessing already adds padding to make the length of input as 200, so the dimension of the output matrix from this layer is (100, 200), in which is corresponding to 100 vectors of length 200 corresponding to 100 input words (including paddings).

The weights in the embedding layer are usually pre-trained with an approach such as skip-gram or Glove. Such approach tried to push the vectors of words in similar contexts to be closer to each other. However, such prediction is not necessarily accurate for the certain words that occur sparsely in the pre-training data set. To address this problem, knowledge bases including word synonyms/antonyms are also used to further adjust the vector representation for these words. In some embodiments, additional extra knowledge base resources for the domains of relevance are added, for example, such as clothing, cosmetics, furniture, etc., in the context of consumer products.

There can be some misalignment between the pre-training dataset and the dataset for the semantic understanding training, so these weights are still updated in additional training in later stages. As noted below, misalignment can be a major technical challenge. To overcome misalignment issues, in some embodiments, there is inserted another stage in the training to alleviate such misalignment, converting the two-stage training to three-stage training.

### NLP and Query Understanding Component—Neural Network Architecture—Convolutional Layers

A few convolutional layers are stacked after the embedding layer to incorporate the short context information. One convolutional layer receives the matrix from the previous layer as the input and runs a sliding window on this matrix.

At each step, the content in the window is considered and transformed. While the embedding layer only translates words to vectors and considers each word independently, the convolutional layers take into account of all the content inside the window, so it considers the semantic meaning not only about individual words but also short context.

For example, if the matrix's dimension is (100 rows, 200 columns), and the sliding window size is 3, it first takes the first (3 rows, 200 columns) sub-matrix as the input and makes it as a flat vector containing 600 elements.

A non-linear transformation is applied on this vector and output another vector (such non-linear transformation is usually a linear transformation step—matrix multiplication plus a nonlinear function such as sigmoid or rectified linear unit). And for the next step, it will take the next (3 rows, 200 columns) from the 2nd row (corresponding to the second word) and run the same non-linear transformation. After moving over the whole sequence, it will get a new matrix of the text representation that considers the short context information.

In natural language, some phrases are actually longer than the others, so this model does not only use the convolutional layer with one fixed window size. Instead, the network contains multiple versions of the sliding window sizes, so it can capture the phrases with various lengths. Outputs of different versions of convolutional layers applied on the same inputs are concatenated together to compose the final output for this layer.

The Cony-layer 234 translates the context in one window to a fixed vector. For example, the output of each step from the previous layer is a 300-dimension vector, and the window size is 2, then the cony-layer put 2 steps of context into consideration, so it concatenates 2 vectors of size 300, i.e., 600-dimension vector as the input, and runs a non-linear transformation (e.g., linear transformation and then a rectified linear function) to convert this to an output vector, e.g., 400-dimension vector.

Multi-size cony-layer captures the features of both longer and shorter context. For example, in natural language, it has two-word, three-word or four-word phrases. In an example embodiment, one version takes the concatenation of 2 vectors and transforms them to one vector of e.g., size 400, another version takes the concatenation of 3 vectors and transforms them to one vector of e.g., size 400, and then the output for each step is a vector 800, capturing both two word features and three-word features.

### NLP and Query Understanding Component—Neural Network Architecture—Recurrent Layers

Convolutional layers 234 are capable to capture the short context information, but it's more challenging for them to incorporate the information across a long text description. Recurrent layers are used for this. In the system, the recurrent layers are stacked after the convolutional layers with the short-term dependencies captured already.

A Recurrent layer 236 takes the output matrix from the previous layer, and runs the non-linear transformation for each step. Unlike the convolutional layers 234 in which the non-linear transformation is only applied to the input vector, the recurrent layers 236 apply the non-linear transformation on both the input vector and the state vector from the previous step. The state vector is updated using the information of the state vector from the previous step, and the state vector from the previous step uses the information from the state vector of one more step further, so the dependency is recurrent, and the state vector embeds all the information from the beginning of the sequence to the current step. In this way, the recurrent layer can contain longer-term context information.

In some embodiments, a variation of recurrent layers called gated recurrent units which have gates to control how much information is kept in the state vector in each step.

At each step, the understanding is incomplete if the network only goes from the left to the right, because some information can be only disambiguated with full context from both sides. For each recurrent layer, the network is the concatenation of two recurrent layers from the left to the right and from the right to the left respectively.

### NLP and Query Understanding Component—Neural Network Architecture—Multi-head Attention Layers

The network is used to predict the semantic understanding for a piece of text. When the text becomes longer, even the recurrent layers are not able to capture all the information in the state space. Certain information is lost during the passing. Attention mechanism is used to alleviate this situation.

In single-head attention mechanism, one categorical distribution across all the words in the text is constructed. This distribution represents how important each word in the text is to decide the output for the neural network.

The semantic understanding model has multiple outputs, including all possible categories and attributes, so it has multiple heads, meaning multiple attention distributions across words are constructed simultaneously. Each possible semantic class owns one head (i.e., one distribution). For example, for the query “burgundy jackets for men”, then the probability of attention associated with the semantic class “COLOR: RED” is likely to be high on the word “burgundy”.

The overall representation of one head h can be represented in the way: Σᵢ₌₁ⁿ⁺¹ pᵢ ^{(h)}sᵢ, where pᵢ^{(h)} means the importance of position i for this head h and sᵢ is the vector representation of position i from the previous layer output. Note the candidate positions for the attention is from 1 to n+1, which is 1 more position than the actual number of words in the text. This one extra word is a fake word to deal with the situation when the semantic class is not related to the text, and it can guide the attention to this fake position instead of some random positions. For example, for the query “burgundy jackets for men”, the probability of attention associated with the semantic class “MATERIAL: LEATHER” is likely to be low for all these words but high for the fake word put at the end of the text.

The construction of the attention distribution can be based on the representation of the previous layer as well. In some embodiments, it is constructed in a way that pᵢ^{(h)} ∝ exp(vₕ^{T} sᵢ), which is the softmax function respecting to the dot product of corresponding representation for the semantic class (vₕ, which is a vector of learnable parameters).

### NLP and Query Understanding Component—Neural Network Architecture—Output Layers

The output layer is just a simple linear transformation layer to translate the vector representation of each head to one scalar number and apply the logistic function on the top of that so the output value is between 0 and 1. If the output value is greater than 0.5 for one semantic class, it usually means that the class is related to the input text.

### NLP and Query Understanding Component—Neural Network Training

The network can be trained in the mini-batch stochastic gradient descent manner with back propagation weight updates.

### NLP and Query Understanding Component—Neural Network Training—Training Approach

The training approach first initialized the network with small weights connections, and then adjusts those weight based on multiple iterations of training. For each iteration, it takes a small batch of training examples including both input signals (text) and expected outputs (semantic classes). A forward propagation is first taken as each example goes through the network from the input layer to the output layer and get the predicted output.

For example, for certain words or word combinations that do not appear often in the training data set, the associated weights are not well trained, thus those weights have larger variance. In prediction, the actual weights that used in the forward propagation are sampled from the distribution decided by the mean and variance, so the actual weights across different runs are likely to be very different to each other, and it makes very diverse output across runs, leading larger variance output.

The predicted output is compared to the expected output. The network is expected to adjust the weights so that the predicted output can be close to the expected output. Such closeness is defined by a loss function.

For the semantic class detection problem, the negative log-likelihood loss function is used to measure the loss (or cost) of the prediction being far away from the expected value. It is defined as loss(y,y′)=−ylog(y′)−(1−y)log(1−y′), where y is the expected output, either 1 (this semantic class is related) or 0 (not related), and y′ is the predicted output. When the expected output is 1, this loss function gives larger loss if the prediction value y′ is small.

The training processing adjusts the weights so it can reduce the loss from the expected value and the predicted value. The most aggressive direction to modify the weights is in the direction of the gradient of the loss.

For each weight, the adjustment is made in this way:

$${w}_{t + 1} = {w}_{t} - σ \frac{\partial L}{\partial w} .$$

In a deep network, the gradient is calculated using the chain rule so the loss can be back propagated from the output layer back to the input layer.

This process is run for each mini-batch of examples, in some embodiments, all the examples in one mini batch are run in parallel. When certain stop conditions are met, the training is stopped. In this system, a cross-validation early stop is made as a stop condition.

All the training dataset is split into two parts as training and validation subsets. The data for training is only sampled from the training subset, and the model predicts for the examples in the validation subset so the model quality is evaluated. The validation evaluation score goes up over time, and the training is stopped when the validation performance score stops improving for a few mini-batches.

### NLP and Query Understanding Component—Neural Network Training—Multi-stage Training

The training process has 3 stages: (1) Domain-Independent, Task-Independent Pretraining, (2) Domain-Dependent, Task-Independent Pre-training, and (3) Domain-Dependent, Task-Dependent Training.

First, Domain-independent, task-independent pretraining is used to learn the generic language structure and word meanings. The system uses the same neural network architecture except for the output layer. The output layer in the pretraining is to predict the next word at each position given the context at the left side of the position. The output layer is a softmax layer with V neurons, where V is the size of the vocabulary.

The network is trained on a huge domain independent dataset. The dataset is a large set of sentences, and the training approach tries to predict each word in the sentence given all the word appearing before the predicted word. The training starts from small random connection weights in the network and adjusts these connection weights via backpropagation.

In this stage, the neural network runs the generic language modeling task on generic language data set. Generic language modeling task is to predict the next word given all the prefix words in sentences. For example, for sentence “This is really a good dress for my wedding”, the corresponding language modeling examples will be:
example 1. input: “this” , output: “is”
“example 2. input “this is” , output “really”
example 3. input “this is really”, output “a”
example 8. input “this is really a good dress for my”, output “wedding”

The generic language data sets include Wikipedia, general crawled web pages, etc. The network architecture for this task is similar to the task specific network but does not include the attention layer and output layer.

Second, domain-dependent, task-independent pretraining is used to refine the network with domain specific knowledge. The architecture of the network and the training procedure is the same as the first stage, but the feeding data is the mixture of the domain-specific data and general data.

The domain-specific data provides information about this domain, e.g., domain-specific vocabulary, the specific meaning of words/phrases. And the general data prevents the network from catastrophic forgetting during the training process. In this stage, the training does not start from scratch, but from the network that is trained from the previous stage, i.e., all the connections and weights are copied from the previous network, and then these weighted are adjusted via backpropagation using the mixed data.

In this stage, the network is fined tuned for the same language modeling task, but for domain specific language resources.

In the third and last stage, the model is fine-tuned to run the understanding task, and use the exact architecture as described. In this stage, the task-specific data is used. The task-specific data contains a set of (text, semantic classes) pairs, in which the semantic classes tell the system which activated semantic classes are related to the text. This training data set is fed into the network, and connection weights are adjusted via backpropagation using the task-specific data.

This stage is the real training for the final network, the tasks are either category detection or attribute detection task

### NLP and Query Understanding Component—Neural Network Training—Dynamic Field and Word Dropout

In some embodiments, an approach uses field and word dropout in the training process to improve the robustness of the model.

Word dropout mechanism decides to drop certain words in the training text to simulate the scenario in the test environment. In training, every word in the text has a distributed embedding representation corresponding to it, but such representation might not be available in the test. To simulate such situation, each word in the training data set is assigned a dropout distribution. The training process usually went through the whole training corpus a few times (each time or pass is called an epoch). For each epoch, a word in the text is decided to be dropped or kept with respect to this distribution. The distribution is estimated based on the popularity of the word: one word is more unlikely to be dropped if this word is more popular. Note that this decision is a sampling process, and is made for each epoch. One word in the text can be dropped in one epoch but is kept in the next epoch.

For the content understanding, the product has its information in multiple fields such as title, description, reviews, etc. Training data is usually well curated and maintained, so it does not have many missing fields, but this happens often at the prediction time. This system also dynamically drops certain field based on the missing distribution for each field type.

### Answer Quality Evaluation

This component evaluates the quality of the answer (search results) towards a query. The quality score can help to make the decision if the original query should go to a human agent or not. If the answer quality score is high, the search results are sent back to the user directly, otherwise, the original query is sent to an agent, and the agent provides a list of relevant search results.

The answer quality evaluation component works in 2 steps: First, it collects the features that can help determine the quality of the answer. Query understanding component provides information such as the uncertainty and risk of the query understanding prediction, and it also gives information about the coverage of query words that it understands, and search component provides matching information about the candidate product to the query especially the part which the query understanding component does not understand. Second, all these features are fed into a quality decision module to predict an answer quality score measuring how good the search result quality is.

The uncertainty information is the variance of the network output across multiple runs. A larger variance of the output indicates larger uncertainty;

The risk information is decided by the average of output across multiple runs. If the output value is close to 0.5 for certain semantic class, it indicates high risk for such prediction, because this prediction is close to the boundary.

Answer Quality Evaluation—Collecting Related Features for Evaluating Answer Quality—Uncertainty and Risk from Bayesian Neural Network

For query evaluation, some embodiments are adapted to utilize a Bayesian neural network, an extension of conventional neural networks. Bayesian networks can provide additional uncertainty information for the prediction. In Bayesian neural networks, there are two values associated with one network connection (weight): the expectation $\mu$ and the variance $\sigmâ2$. The Bayesian neural network gives the systems some sense of the uncertainty on the network connections. For example, if the expectation of one connection is fixed, but one version of the network has a large variance on this connection, it indicates that the confidence about the strength of the connection is lower.

In the forward propagation of Bayesian network, the weight of the connection is sampled at real time from the underlying distribution $w \leftarrow N(\mu, \sigmâ2)$, so this is a sampling processing instead of a deterministic processing. In the training process, one training example can generate multiple versions of outputs with different sampled connection weights. All these input and sample output are put together to train the network following the same backpropagation procedure to update both the expectation and the variance of the parameters.

Using the Bayesian neural network, it can produce both uncertainty and risk information.

The uncertainty information of the prediction is provided by evaluating the outputs from multiple rounds of forwarding propagation process. Given an input, this system runs the input through the network for a number of times, the neural network can give multiple versions of the output. The uncertainty is defined as how much disagreement between these versions of outputs. The larger degree of disagreement indicates the larger uncertainty about the output. The degree of the disagreement is measured by the variance of the output scores for each category. Only the uncertainty information for those categories and attributes that are activated or almost activated is used.

$$unc ( o ) = \frac{{\sum }_{{o}_{i} ∈ A} var ( {o}_{i} )}{AV} ,$$

where oᵢ is an individual output variable corresponding to a semantic class, and its value is between 0 and 1, indicating how strongly the system believes this semantic class is related to the input var(oᵢ) is the variance of the variable oᵢ corresponding to one of the output semantic class. The system passes the input through the network a few times, so the variance can be calculated. A is a set of output classes that are activated or almost activated {oᵢ V ∃j, oᵢ^{(j)}>0.5−ϵ}, where ϵ is a small positive value so that the almost activated semantic class is also considered, oᵢ^{(j)} is the output for i-th semantic class on j-th round of forwarding propagation.

The risk information of the prediction is provided by considering how far each output is close to the boundary. And the entropy is used to calculate the risk: risk(o)=max, where ōᵢ the average of outputs for all samples on a semantic class:

$${\overline{o}}_{i} = \frac{{\sum }_{j = 1}^{J} {o}_{i}^{( j )}}{J} ,$$

where j is the total number of samples.
Answer Quality Evaluation—Collecting Related Features for Evaluating Answer Quality—Coverage from Activated Attention Heads

From the attention layer in the neural network, each activated semantic class is associated with an attention head, which is a distribution of attention on words in the text. Given the distribution of the attention, a chunking approach is used to detect the chunks of words in the text that are associated with the semantic class. A chunk of words is a sequence of adjacent words in the text that is corresponding to strong attention for the given head.

The chunking approach runs for each head of activated semantic classes. It starts from the position with the maximal attention as a chunk of length 1. And then it works in a recursive manner to look each side of the chunk, and extend the chunk at one direction if such extension does not lead to a significant drop of the overall attention on the chunk. All the words in the chunk are considered to be associated with the corresponding activated semantic class.

In this way, the system gathers all the words that associate with at least one activated semantic class. The system can understand the semantic meaning of these words. On the other hand, those words that are not associated with any of the activated semantic class are considered to be not covered by the query understanding component. And these words should be captured by the search component.

Answer Quality Evaluation—Collecting Related Features for Evaluating Answer Quality—Coverage from Search

For those words that are not understood by the query understanding component, it's expected to have products that can match these words. If those words are very unpopular and cannot find the corresponding match from the results. It indicates the quality of the search results is not good. Some embodiments are adapted to collect such coverage information for each of those words and the combination of those words.

For each of the word, it needs to get all the matching information from the product catalog, including the number of matched products and the matching score distribution. These features are defined on each individual word in the query, and the aggregation on the max, min, and average of these features are calculated to measure the search coverage from the statistical point of view.

Also, it needs to get the search coverage of all the uncovered words. A query containing all the query words that are not understood is composed to search on the catalog, and the number of matched products, as well as the score distribution, are extracted as a measure for the overall coverage.

In addition to the coverage measure from search, the system also searches the whole original query on the catalog, and get the number of matched products and matching score distribution.

### Answer Quality Evaluation—Evaluating Answer Quality

From query understanding component and search component, the system has collected features that are related to the search result quality including Risk estimate from query understanding, Uncertainty estimate from query understanding, Coverage features from attention module of query understanding, Coverage features from search, and Matching features from search.

All these features are aggregated together to predict the quality of the overall search results. A supervised machine learning model is used to make this prediction.

### Answer Quality Evaluation—Evaluating Answer Quality—Training Quality Evaluation Model

A training data set is prepared to learn the quality evaluation model. There are several training suites in the training data. Each training suite contains a product catalog, a query set, and the relevance judgments for each query.

The product catalog is a large set of products that are used as the candidate to answer the customers' queries. The catalog sizes vary across suites, range from a few thousand to a few million products.

The query set is associated with the product catalog in the same training suite. These are queries are related to overall categories of the catalog.

The relevance judgments are defined for each query. It labels all the relevant products to the query with the degree of relevance.

Given a training data set and a running system, the training examples can be extracted by running all queries on the system. Each extracted training example has two parts: the input features part and the expected output part.

Given a query, its relevance judgments and the corresponding catalog in a training suite, the system runs the query and collects all the features from the query understanding and search component. All these features are used as the input part of the training example.

The system runs this query toward to the corresponding catalog through the query understanding and search pipeline and gets a list of products that the system considers as relevant to the query. This list of products are compared to the relevance judgments, and an expected quality score for this query is given. If most of the top returned products are actually relevant to the query, the expected quality score is high. Otherwise, the expected quality score is low. This quality score is the output part of the training example. The answer quality model is trained on these (features, quality score) training examples.

The model predicts a quality score given the features extracted from the pipeline for a particular query. The quality score is then used to decide if this query is forwarded to an agent or not.

The model is trained to decide the relative quality across different queries, so the model is trained in a pairwise manner. For each iteration, the training approach picks a list of training examples pairs. Each pair of training example are generated from two queries, so it has (x|1, y₁) and (x|2, y₂), where x₁ and x₂ are features and y₁ and y₂ are quality scores. Assuming for this pair of training example, y₁>y₂, meaning the answer quality for the first query is better than the answer quality of the second one.

The training approach first runs a forward propagation pass, getting the prediction score ŷ₁ and ŷ₂. If ŷ₁>ŷ₂, meaning the answer for the first query is also predicted to have better quality than the second query, it means the model performs perfectly, and no adjustment is required for the model. On the other hand, if ŷ₁≤ŷ₂, it means the model predicts that the second query has better quality. In this case, the backpropagation is made to update the weights of the model so that it can lower ŷ₂ and bump ŷ₁.

The model training process runs in a mini-batch model. For each iteration, it picks a batch of training example pairs, runs a forward pass, and gets the signal to run the backpropagation. This process repeats until one of the early stop conditions is met. The early stop conditions includes: the maximal number of iterations, the number of prediction errors on the validation set stops to decrease in the last few iterations.

The mechanism then is configured to generate a dynamically rendered interface that is used by a search specialist in quickly selecting one or more candidate categories that best fit the user's query. The speed at which the candidate categories are processed is an important factor in some embodiments. The dynamically rendered interface includes visual elements that are specifically rendered having various visual and/or interactive characteristics that allow the search specialist to easily and accurately select candidate categories in response to the search string.

The reason why speed is important is because in some embodiments, the search assistance of the intermediary is adapted to be as seamless as possible to the user experience. A user, on a retailer website, for example, may experience a slightly longer search time, but is typically unaware of the actions of the intermediary, as the search may take only a few seconds longer than usual (e.g., and there may be a corresponding visual indicator that the search is in progress, such as an hourglass or a spinning ball).

The rendered interface is, in some embodiments, streamlined such that a search specialist is able to make selections with a high level of ease optimized for inputs (e.g., a finger input where the search specialist drags a finger from the center of the rendering to a category, or a mouse input where a mouse position, by default is in the center, and visual distances and screen area are allocated dynamically to the potential candidate categories based on the current confidence score).

An agent component is configured to receive the original query string, the semantic understanding of information and the search results from the delegator component only if the model rejector component decides to reject the result. The interface for the agent component is similar to a search interface, the ranking of the results are affected by the NLP model output, so the most relevant results predicted by the model are ranked at the top of the results. It makes the agent easy to detect and select such relevant results.

### Forwarding the Queries and Answers to Agents

The answer quality evaluation model is applied in two different scenarios: the online scenario and the offline scenario.

In the offline scenario, all the queries for a particular catalog are collected by the system. The system also collects all the intermediate features that are useful to predict the answer quality score, and the search result the system provides for the query. The answer quality evaluation model is used to predict the answer quality for all historical queries. These queries are then ranked by the ascending order of answer quality to the agents, and the agents can pick the queries that have a bad quality score to adjust the semantic classes and search results.

In the online scenario, the queries come in the stream mode. A few queries come to the serving system in minutes, and certain queries have worse answer quality than the others. From the historical query stream, the quality score of the query stream is estimated. Also, the current incoming traffic is tracked by the system. Given both stats, the system can predict the distribution of the number of queries at each answer quality level. Given the number of available agents, the system can dynamically decide the threshold of answer quality to make sure the worst performing queries in the stream is sent to the agents with high probability.

In both offline scenario and online scenario, the agents receive queries with bad answer quality score together with query understanding and search results. The agent can see a dashboard including information including the original query, all activated semantic classes, not activated semantic classes ranked by the relevance score from high to low, and the products from search ranked by the relevance score from high to low.

The agent dashboard is designed in a way to improve the performance of the agents, so they are able to correct the search results and push back to the customers within 5 seconds 80% of the time. The agents can interact with the dashboard to improve the search results. They can do it in many different ways. They can disable an activated semantic class or enable an inactivated semantic class.

It corrects the semantic classes associates with the queries and also makes the search results updated. The agents can also adjust the search results directly, adding a relevant product at a specific position in the existing results or remove a returned product from the search results. After the agents change the search results, these search results are saved for continuous learning to improve the system performance for similar queries in the future. For the online scenario, the corrected search results are also directly push to the end customers so they can perceive good search results immediately.

In this example, the search specialist sees a number of potential candidate categories for ripped jeans, including “distressed jeans”, used pants”, etc., and the potential candidate categories are arranged in the form of a visual constellation of selection points. Relative to the other points, “distressed jeans” is visually more prominent (e.g., larger area, neon color, emphasized position and orientation) and easier to select (e.g., closer to the default position, such as a center of a screen) than the other selection points.

The search specialist is provided a countdown timer (e.g., 5 seconds) upon which to select a selection point representative of a potential candidate category. In this example, the search specialist then selects “distressed jeans”, and the user, unaware of the action of the intermediary, is provided with a page of search results for distressed jeans.

In some embodiments, the search specialist's selection is then provided to a configured neural network that updates weightings and rankings of its internal nodes and connections thereof to bias towards an association of “ripped jeans” with “distressed jeans”. The next time a search query with the term “ripped jeans” is encountered by the mechanism, the confidence assigned to “distressed jeans” as a potential candidate category is increased. A similar mechanism can be utilized to handle abstract queries, such as “toys for 1 month old poodle puppy”.

The neural network may be configured to track the user's behavior following the search term to validate whether the search specialist's selection is correct. The tracked behavior may be a proxy for the correctness of a search, for example, if the user continues a purchase in relation to distressed jeans, the selection was likely correct. If the user is detected to select a “back button” and to initiate a new search (especially where the new search is for a variation on the same wording as the earlier search), then the selection was likely not correct. The mechanism, in some embodiments, utilizes neural networks that are adapted generate “rewards” or “penalties”, the neural networks configured to optimize, over a corpus of search results, the rewards while minimizing penalties.

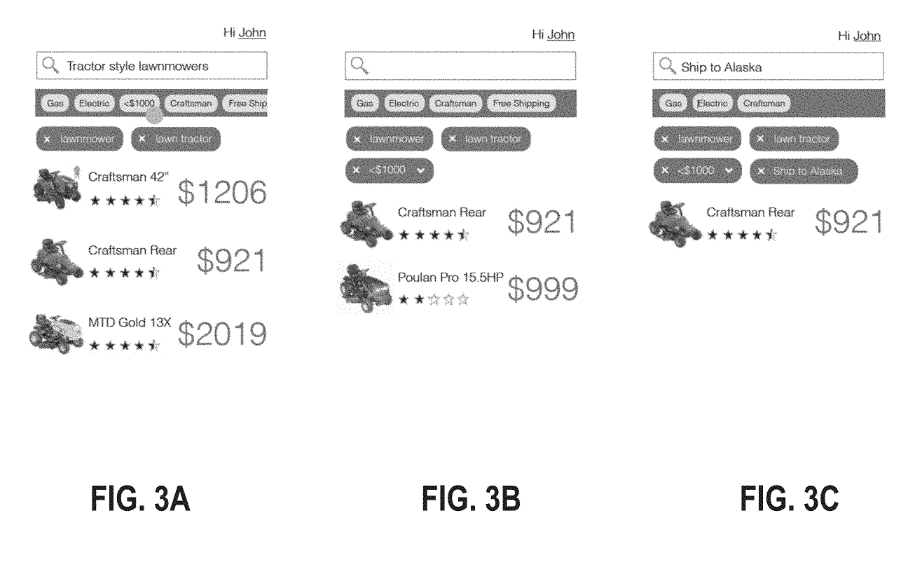

FIG. 3A is an illustration of a search input field that may be used by a user to input a search string in this case, in relation to lawnmowers. In the example of FIG. 3A there are various keywords that are depicted underneath the users search indicate various search terms or other types of indicators that made user in conducting the use of search. It is important to note that these search bubbles illustrate categories which are known to the system. The categories may be shown alongside specific search terms so for example tractors the lawnmowers needs to lawnmower as well as the term lawn tractor turnover categories within the data structure of the retailer. In FIG. 3B, after the user selects a filter indicating that prices are less than <1000, the results are updated to reflect only lawnmowers/lawn tractors with prices below $1000.

In FIG. 3C, an additional filter of “ship to Alaska” is applied, and the results are updated accordingly.

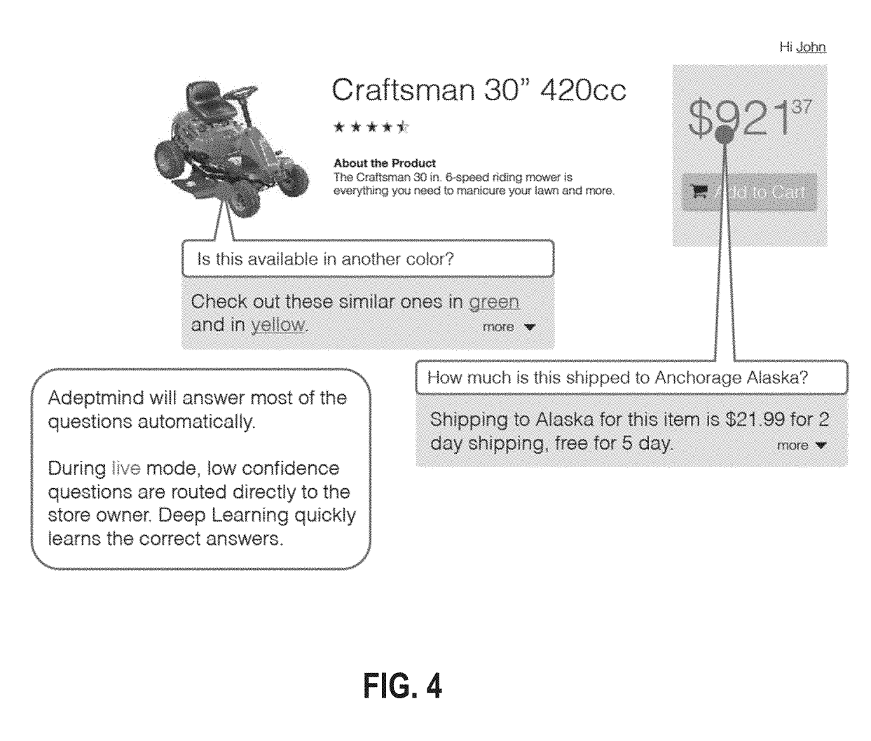

FIG. 4 shows an alternate renderings where the search input field is configured to receive user input representing a query regarding a particular product being displayed. The system operates using a similar or the same process as the examples of product search. However, instead of product search results being displayed, the system generates user interface elements representing potential answers to the query regarding a particular product or products.

A constructed ontology is adapted for understanding as well as generating understandings of documents and representations thereof, which can be used in a neural retrieval model in downstream processing of queries. The neural retrieval model, for example, is adapted to receive queries such as “dress good for the beach”, to generate a data set representative of the system's understanding of the query terms, to be transformed and stored in the form of a query representation. One or more neural network models are then used to attempt to map query terms (e.g., “dress good for the beach”) to documents tracked in a product database, for example, such as candidate product categories (“single piece swimwear”, “burkini”, “lightweight medium length dress”, “sleeveless dress”), among others.

In some embodiments, candidate product categories are assigned confidence scores by the neural retrieval model. Where a high competence is found the search proceeds based on the expected keywords. For example, high confidence can be associated with either an identical search, or where there are slight variations.

On the other hand where low confidence is found, the retrieval model initiates a “man in the middle” or other intermediary process in an attempt to select a candidate product category as a best match. As described in above examples, the selection may be used to update the neural retrieval model such that hidden nodes of the neural retrieval model are biased towards increasingly correct answers as a corpus of data points are processed and received.

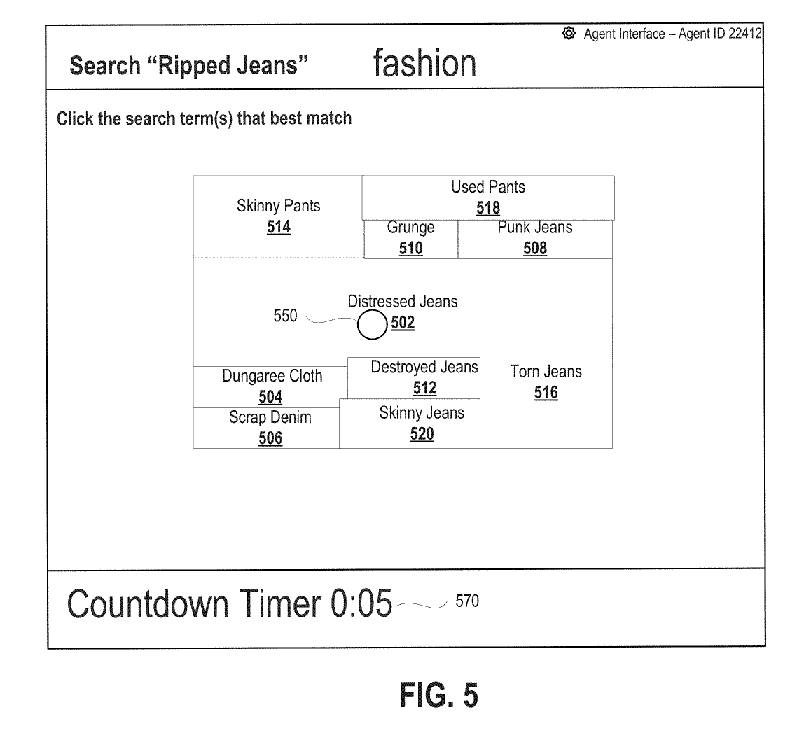

FIG. 5 is an example rendering an interface or a search specialist. The rendering shows space that is streamlined for use by search specialist. This example, the neural network has maintained characteristics of various types of known categories associated with a potential search term. These candidate categories are shown and because there is a low confidence any of the matches matching the users inquiry this case, genes, a number of candidate options are presented to the search specialist on the interface. In this example, the categories are shown from 502, 504, 506, 508, 510, 512, 514, 516, 518, all with different areas and orientations and positioning relative to a default cursor position as shown as circle 550.

In this example, the neural network 212 has output confidence scores associated with various products/services in a catalog, but none of them were high enough to pass a threshold. Accordingly, the neural network 212's output is ranked based on the confidence scores. The ranking and the distance between each of the confidence scores, in some embodiments, is taken into account in factoring size and positioning relative to inputs by the agent.

In a specific example, the agent's interface is a mobile device where the agent is able to log in and use a touch device. Accordingly, the ranking of the confidence scores and the differences thereof are utilized to modify how the touch interface is provided. For example, where distressed jeans=0.5, skinny jeans=0.3, stretchy jeans=0.2 in response to “ripped jeans”, distressed jeans may be positioned as an interactive interface element directly in the area most likely to be touched (e.g., center) or an input most likely to be selected. Skinny jeans and stretchy jeans are allocated areas in accordance with their respective confidence scores, and may be placed to the left, top, down, right, etc., of the main choice. For example, distressed jeans may be assigned 50% of the surface area (e.g., in the form of a rectangular button), skinny jeans 30% of the surface area, and stretchy jeans 20% of the surface area.

Furthermore, distressed jeans is assigned the best positioning (default mouse click/input signal positioning), and skinny jeans is assigned the second best positioning, and stretchy jeans is assigned the worst positioning. Accordingly, as confidence differences between classifications widens, the agent interface adapts to give greater prominence to higher confidence classifications.

The user of the interface, the search specialist, is able to quickly click using a mouse or touch input a selected category that best fits search string, in this case, “ripped jeans”. A countdown timer is shown at 570, which then upon either a selection of a category, or a lapse of the search term over to the next term.

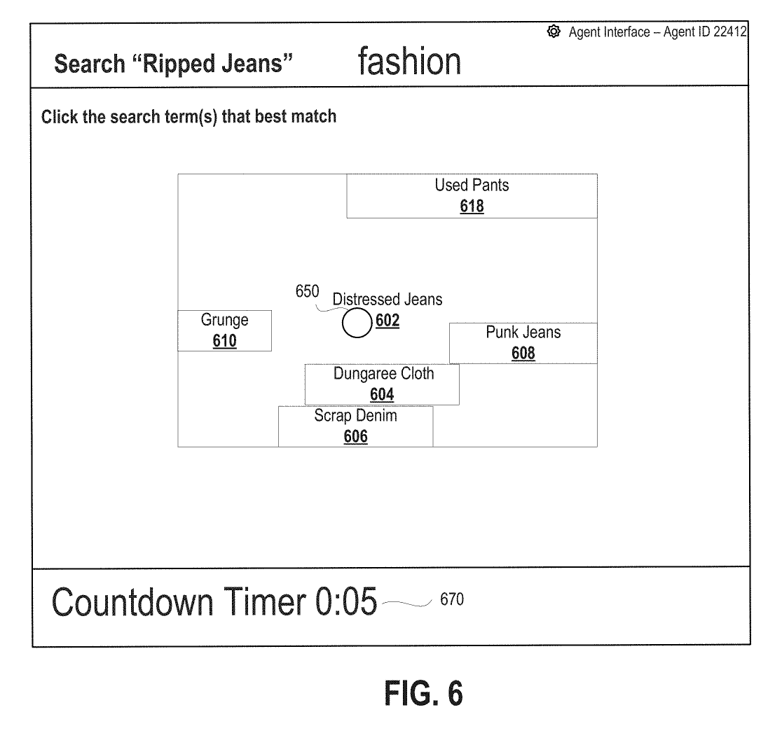

FIG. 6 depicts a similar interface, however, relative to FIG. 5, different categories shown are with different visual renderings, including position, area, and distance from the default mouse position 650. In this case, the “distressed jeans” is a fairly confident selection, and is afforded a large amount of area relative to the other search terms. A countdown timer is shown at 670.

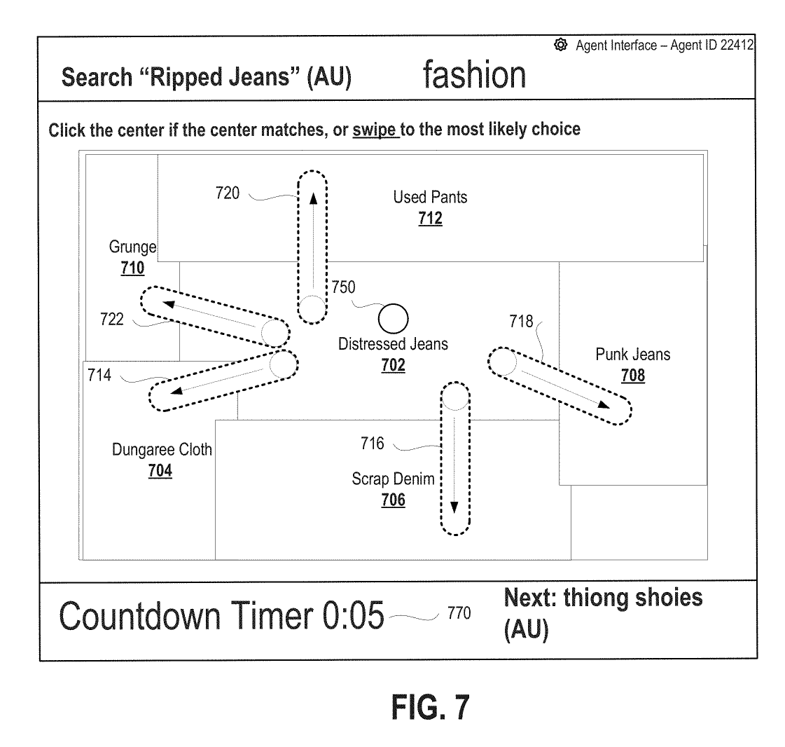

FIG. 7 is an alternate rendering whereby rather than being optimized for a mouse selection, the rendering of FIG. 7 is designed for interaction with the search server search specialist by way of a touch action in the middle as shown at circle 750 or a swipe action in relation with paths (shown in phantom) 714, 716, 718, 720, and 722. These correspond to category terms 702, 704, 706, 708, 710, and 712. A countdown timer is shown in 770. Once the selection is made, the interface moves on to the next search string, in this case, “thiong shoes”, which is noted to come from an Australian internet protocol address (to indicate context for the search specialist).

In some embodiments, based on the confidence scores, the positioning of the centroids of the interactive interface elements corresponding to category terms 702, 704, 706, 708, 710, and 712 is also adapted, in addition to the surface areas assigned to each interactive interface elements. For example, on touch devices, the center is the easiest to touch, followed by a swipe right, then a swipe left, then a swipe up, and finally a swipe down. The interactive interface elements corresponding to category terms 702, 704, 706, 708, 710, and 712 can be positioned in descending order in accordance with the centroid positioning of interactive interface elements.

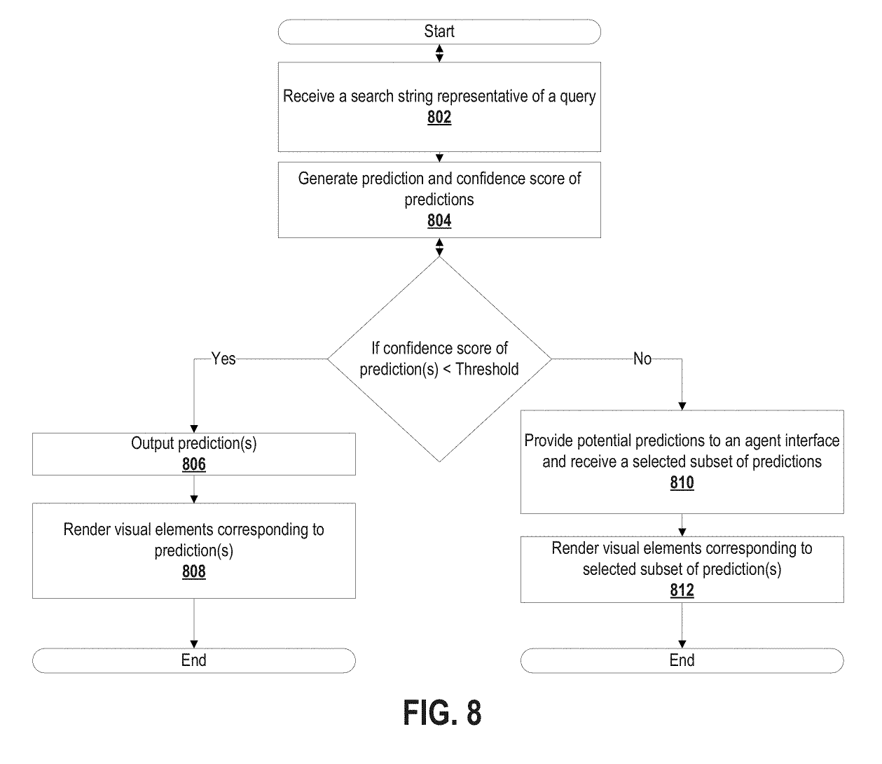

FIG. 8 is an example method, and the method is shown via steps 802-812. In FIG. 8, the method includes first receiving the search string that is representative of a query at step 802, then generating a prediction confidence score of predictions at 804. The predictions are categorized and if the confidence score is greater than a threshold the predictions are output to the user at 806, and visual elements that correspond to the predictions are rendered at 808. In this path, for example, a search was provided with sufficient clarity such that the system is able to process the search without requiring the use of a search intermediary.

On the other hand, if the confidence for conditions is below a particular threshold, potential predictions are provided to an agent interface and a selected subset of predictions are received from the agent through the interface, the agent interacting with the interface visual elements at 810. Once the selected subset of predictions are provided, these predictions are then rendered in the form of a results page or other type of visual output. For example, the user searches “ripped jeans”, the agent selects “distressed jeans”, and a results page indicative of “distressed jeans” is shown instead, rather than a query response of “unable to find any relevant results”.

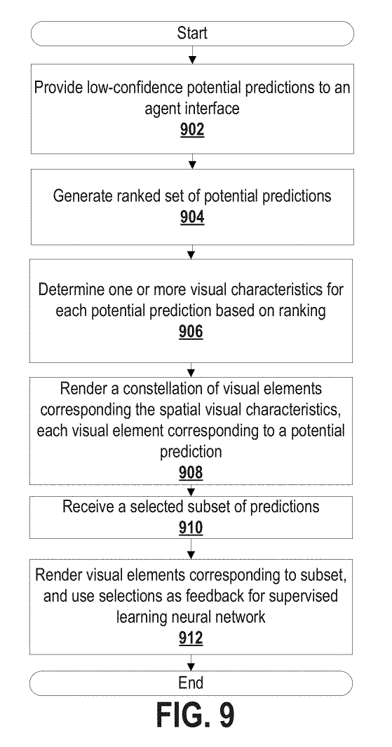

At FIG. 9 an example method is shown for rendering the visual elements for the supervised user interface, according to some embodiments. At 902, the system configured to provide a low confidence potential predictions to an agent interface. The system generates a ranked list of predictions at 904, and based on the ranking of predictions, visual elements are initialized and adapted based on their rankings and/or the confidence score of each prediction at 906.

At 908 these visual characteristics are utilized to render a constellation of visual elements that correspond to spatial and/or or visual characteristics of these on the interface screen. For example, each visual element can corresponds to a particular prediction, and may be assigned or otherwise provisioned visual characteristics, such as a visual area on the screen, a shape, a location, a color, etc.

A received subset of predictions is obtained from the search specialist at 910 and these visual elements are then rendered as results for the user on the user's interface, without the user being aware of the intervention of the intermediary (e.g., the search specialist). In some embodiments, the user's subsequent behavior and/or the search specialist's selection are then used as feedback for supervised learning for neural network 112.

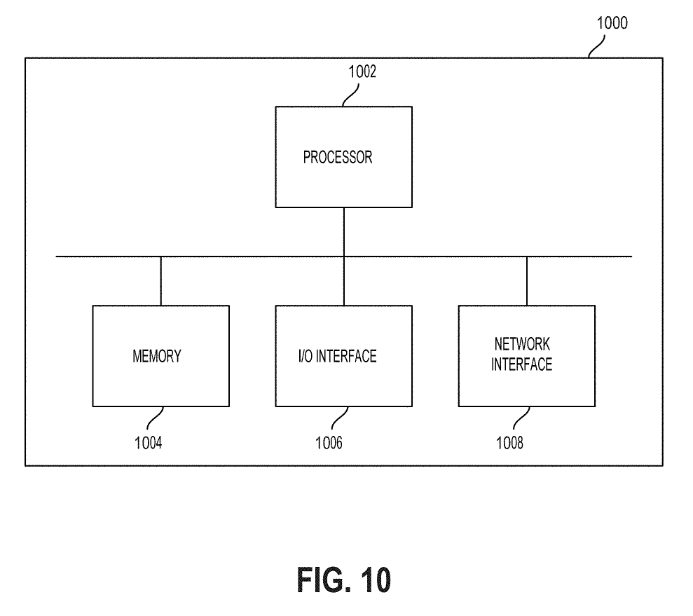

FIG. 10 is a block schematic diagram of an example computing device, according to some embodiments. There is provided a schematic diagram of computing device 1000, exemplary of an embodiment. As depicted, computing device 1000 includes at least one processor 1002, memory 1004, at least one I/O interface 1006, and at least one network interface 1008. The computing device 1000 is configured as a tool for dynamic search generation and support.

Each processor 1002 may be a microprocessor or microcontroller, a digital signal processing (DSP) processor, an integrated circuit, a field programmable gate array (FPGA), a reconfigurable processor, a programmable read-only memory (PROM), or any combination thereof. The processor 1002 may be optimized for search query processing and neural networking.

Memory 1004 may include a computer memory that is located either internally or externally such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM).

Each I/O interface 1006 enables computing device 1000 to interconnect with one or more input devices, such as a keyboard, mouse, camera, touch screen and a microphone, or with one or more output devices such as a display screen and a speaker. I/O interface 1006 may also include application programming interfaces (APIs) which are configured to receive data sets in the form of information signals, including keyboard inputs, verbal inputs, image search selections.

Each network interface 1008 enables computing device 1000 to communicate with other components, to exchange data with other components, to access and connect to network resources, to serve applications, and perform other computing applications by connecting to a network (or multiple networks) capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. WiMAX), SS7 signaling network, fixed line, local area network, wide area network, and others.

Program code is applied to input data to perform the functions described herein and to generate output information. The output information is applied to one or more output devices. In some embodiments, the communication interface may be a network communication interface. In embodiments in which elements may be combined, the communication interface may be a software communication interface, such as those for inter-process communication. In still other embodiments, there may be a combination of communication interfaces implemented as hardware, software, and combination thereof.

Throughout the foregoing discussion, numerous references will be made regarding servers, services, interfaces, portals, platforms, or other systems formed from computing devices. It should be appreciated that the use of such terms is deemed to represent one or more computing devices having at least one processor configured to execute software instructions stored on a computer readable tangible, non-transitory medium. For example, a server can include one or more computers operating as a web server, database server, or other type of computer server in a manner to fulfill described roles, responsibilities, or functions.

The technical solution of embodiments may be in the form of a software product. The software product may be stored in a non-volatile or non-transitory storage medium, which can be a compact disk read-only memory (CD-ROM), a USB flash disk, or a removable hard disk. The software product includes a number of instructions that enable a computer device (personal computer, server, or network device) to execute the methods provided by the embodiments.

The embodiments described herein are implemented by physical computer hardware, including computing devices, servers, receivers, transmitters, processors, memory, displays, and networks. The embodiments described herein provide useful physical machines and particularly configured computer hardware arrangements.

Although the embodiments have been described in detail, it should be understood that various changes, substitutions and alterations can be made herein.

Moreover, the scope of the present application is not intended to be limited to the particular embodiments of the process, machine, manufacture, composition of matter, means, methods and steps described in the specification.

As can be understood, the examples described above and illustrated are intended to be exemplary only.

What is claimed is:

1. A computer system for dynamic online search result generation, the system including:
a processor operating in conjunction with computer memory, the processor configured to:
maintain a neural network with multi-headed attention layers configured for constructing multiple attention distributions simultaneously, each possible semantic class corresponding to a specific head;
receive a search string representative of a query;
process the search string to extract one or more search terms;
for each head of the neural network:
process the one or more search terms expanded with a nonce search term to establish a corresponding attention probability distribution associated with the corresponding semantic class;
based at least on the constructed multiple attention distributions:
identify one or more candidate categories associated with the search term from a pre-defined set of candidate categories; and
process the one or more candidate categories to associate each candidate category with a confidence score.

2. The system of claim 1, wherein the processor is further configured to:
upon determining that none of the one or more candidate categories has a confidence score above a threshold value:
associate each of the candidate categories with one or more visual characteristics based on the confidence scores;
render an interface display screen based on the one or more visual characteristics, the interface display screen including interactive visual elements that selectable in relation to the one or more candidate categories;
receive, from an input device, a selected subset of the one or more candidate categories; and
generate an output representative of the selected subset of the one or more candidate categories.
wherein the interface display screen is configured to render a constellation of visual elements representative of the one or more candidate categories;
wherein the constellation includes a visual rendering of selectable areas, each selectable area representative of a candidate category of the one or more candidate categories; and
wherein each selectable area is rendered based on the visual characteristics, and the visual characteristics include at least one of screen area, color, position, and shape.

3. The system of claim 2, wherein the threshold value is modified depending on an availability of human agent resources to provide inputs indicative of a selected candidate category of the one or more candidate categories.

4. The system of claim 2, wherein the processor is configured to re-train the neural network with the selected candidate category of the one or more candidate categories as a labelled training data element, adjusting weights within connected nodes of the neural network to minimize a loss function.

5. The system of claim 1, wherein maintaining the neural network includes a three-staged training process including at least:
a first domain-independent, task-independent pre-training stage for adapting the neural network to language structure and word meanings;
a second domain-dependent, task-independent pre-training adapted for refining the neural network with domain specific language; and
a third understanding task stage adapted for processing sets of text, semantic class pairs of data wherein the semantic classes indicate which activated semantic classes are related to the text, and connection weights of the neural network are adjusted using back propagation.

6. The system of claim 1, wherein maintaining the neural network includes utilizing at least both a field and a word dropout mechanism during the training process adapted for improving model robustness;
wherein each search term in a training data set is assigned a dropout distribution; and
wherein during each epoch of training, a search term is dropped or kept in accordance with the dropout distribution;
wherein the dropout distribution is estimated based on a determined popularity of the search term.

7. The system of claim 2, wherein the determination of the confidence score includes:
collecting one or more features that help determine the quality of the answer; and
providing the one or more features into a quality decision component adapted to predict an answer quality score.

8. The system of claim 7, wherein the quality decision component includes a Bayesian neural network that generates a confidence score based at least on an expectation determination and a variance determination.

9. The system of claim 8, wherein the Bayesian neural network is adapted to sample a weight of a connection during forward propagation, and during the training process, a training example is used to generate multiple versions of outputs with different sampled connection weights, and wherein the inputs along with the outputs are utilized to train the neural network during a backpropagation procedure to update both the expectation determination and the variance determination.

10. The system of claim 9, wherein the Bayesian neural network provides data sets indicative of uncertainty information and risk information associated with a particular prediction.

11. A computer implemented method for dynamic online search result generation, the method comprising:
maintaining a neural network with multi-headed attention layers configured for constructing multiple attention distributions simultaneously, each possible semantic class corresponding to a specific head;
receiving a search string representative of a query;
processing the search string to extract one or more search terms;
for each head of the neural network:
processing the one or more search terms expanded with a nonce search term to establish a corresponding attention probability distribution associated with the corresponding semantic class;
based at least on the constructed multiple attention distributions:
identifying one or more candidate categories associated with the search term from a pre-defined set of candidate categories;
processing the one or more candidate categories to associate each candidate category with a confidence score.

12. The method of claim 11, further comprising:
upon determining that none of the one or more candidate categories has a confidence score above a threshold value:
associating each of the candidate categories with one or more visual characteristics based on the confidence scores;
rendering an interface display screen based on the one or more visual characteristics, the interface display screen including interactive visual elements that selectable in relation to the one or more candidate categories;
receiving, from an input device, a selected subset of the one or more candidate categories; and
generating an output representative of the selected subset of the one or more candidate categories.
wherein the interface display screen is configured to render a constellation of visual elements representative of the one or more candidate categories;
wherein the constellation includes a visual rendering of selectable areas, each selectable area representative of a candidate category of the one or more candidate categories; and
wherein each selectable area is rendered based on the visual characteristics, and the visual characteristics include at least one of screen area, color, position, and shape.

13. The method of claim 12, wherein the threshold value is modified depending on an availability of human agent resources to provide inputs indicative of a selected candidate category of the one or more candidate categories.

14. The method of claim 12, comprising: re-training the neural network with the selected candidate category of the one or more candidate categories as a labelled training data element, adjusting weights within connected nodes of the neural network to minimize a loss function.

15. The method of claim 11, wherein maintaining the neural network includes a three-staged training process including at least:
a first domain-independent, task-independent pre-training stage for adapting the neural network to language structure and word meanings;
a second domain-dependent, task-independent pre-training adapted for refining the neural network with domain specific language; and
a third understanding task stage adapted for processing sets of text, semantic class pairs of data wherein the semantic classes indicate which activated semantic classes are related to the text, and connection weights of the neural network are adjusted using back propagation.

16. The method of claim 11, wherein maintaining the neural network includes utilizing at least both a field and a word dropout mechanism during the training process adapted for improving model robustness;
wherein each search term in a training data set is assigned a dropout distribution; and
wherein during each epoch of training, a search term is dropped or kept in accordance with the dropout distribution;
wherein the dropout distribution is estimated based on a determined popularity of the search term.

17. The method of claim 12, wherein the determination of the confidence score includes:
collecting one or more features that help determine the quality of the answer; and
providing the one or more features into a quality decision component adapted to predict an answer quality score.

18. The method of claim 17, wherein the quality decision component includes a Bayesian neural network that generates a confidence score based at least on an expectation determination and a variance determination.

19. The method of claim 18, wherein the Bayesian neural network is adapted to sample a weight of a connection during forward propagation, and during the training process, a training example is used to generate multiple versions of outputs with different sampled connection weights, and wherein the inputs along with the outputs are utilized to train the neural network during a backpropagation procedure to update both the expectation determination and the variance determination.

20. A non-transitory computer readable medium storing machine interpretable instructions, which when executed, cause a processor to perform steps of a method for dynamic online search result generation, the method comprising:
maintaining a neural network with multi-headed attention layers configured for constructing multiple attention distributions simultaneously, each possible semantic class corresponding to a specific head;
receiving a search string representative of a query;
processing the search string to extract one or more search terms;
for each head of the neural network:
processing the one or more search terms expanded with a nonce search term to establish a corresponding attention probability distribution associated with the corresponding semantic class;
based at least on the constructed multiple attention distributions:
identifying one or more candidate categories associated with the search term from a pre-defined set of candidate categories;
processing the one or more candidate categories to associate each candidate category with a confidence score.
